(19) United States
(12) Patent Application Publication
(10) Pub. No.: US 2012/0030562 A1
(43) Pub. Date: Feb. 2, 2012

(54) DEVICE AND METHOD FOR GENERATING CUSTOMIZED WEBPAGES

(75) Inventors: CHENG-YEN TSAI, Tu-Cheng (TW); CHIH-YUAN HUANG, Tu-Cheng (TW)

(73) Assignee: HON HAI PRECISION INDUSTRY CO., LTD., Tu-Cheng (TW)

(21) Appl. No.: 12/905,091

(22) Filed: Oct. 15, 2010

(30) Foreign Application Priority Data
Jul. 30, 2010 (CN) 201010241305.3

(51) Int. Cl. G06F 17/00

(52) U.S. Cl. 715/236

(57) ABSTRACT

A device and method for generating a customized webpage creates a root folder that includes a base folder and language folders. The method creates a symbolic link between each of the language folders and the base folder, and analyzes the web address sent from a terminal device to determine which language is required to display a webpage. The method further locates a language folder from the root folder according to the required language, obtains common webpage files from the root folder through the symbolic link, and translates content of the common webpage files into data in the required language. Additionally, the method obtains a customized file from the language folder and storing the customized file and the translated data into a JavaScript file, generates an HTML file according to the JavaScript file, and displays the customized webpage on a browser of the terminal device according to the HTML file.

### BACKGROUND

1. Technical Field

Embodiments of the present disclosure relate generally to webpage designs, and more particularly to a device and method for generating a customized webpage.

2. Description of Related Art

Dynamic webpages are popular among designers due to ease of design and publication for large and feature-rich websites. Such webpages address the problem of growing and increasingly complex websites, while providing richer features and more detailed and varied content. However, creation, tracking, and maintenance of each distinct customized webpage and interaction with a browser supporting an end-user are limited by language difference.

### BRIEF DESCRIPTION OF THE DRAWINGS

FIG. 1 is a schematic diagram of one embodiment of a computing device for generating a customized webpage.

FIG. 2 is a schematic diagram illustrating one example of creating a root folder using the computing device of FIG. 1.

FIG. 3 is a flowchart of one embodiment of a method for generating a customized webpage using a computing device such as, for example, that of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

As used herein, the term “customized webpage” refers to a webpage customized by an end-user according to end-user requirements. The customized webpage may provide richer features and more detailed and varied content than a common webpage, and can be displayed on a browser of a terminal device in different languages. The content are included in the customized webpage and can be accessed by the end-user, and may include information, image files, audio and video files, for example.

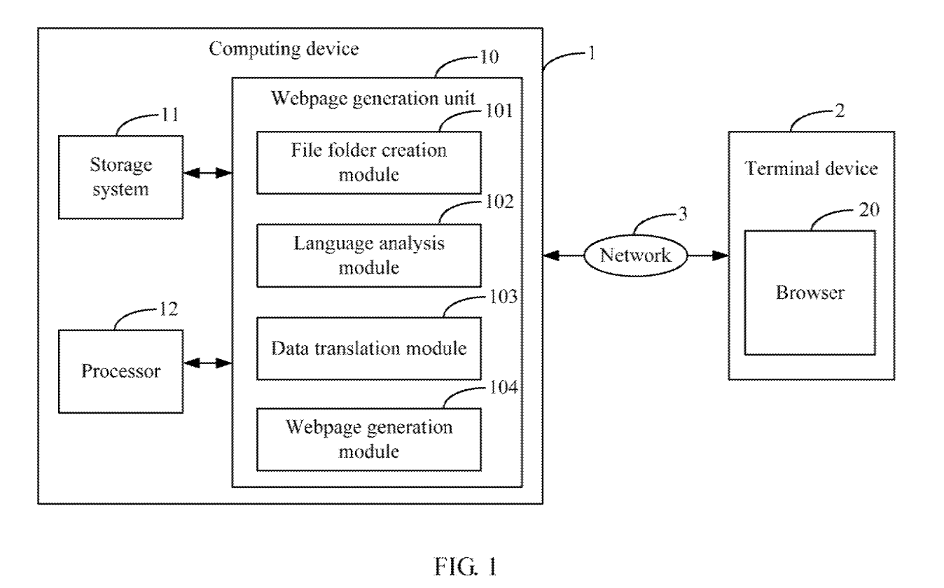

FIG. 1 is a schematic diagram of one embodiment of a computing device 1 for generating a customized webpage. In the embodiment, the computing device 1 can generate a customized webpage that adapts to different user requirements, and displays the customized webpage on a display of a terminal device 2. The computing device 1 may be a gateway, an ADSL modem, a cable modem, or any suitable communication connection device. In one embodiment, the computing device 1 includes a webpage generation unit 10, a storage system 11, and at least one processor 12. It should be understood that FIG. 1 illustrates only one example of the computing device 1, and may include more or fewer components than illustrated, or a different configuration of the various components in other embodiments.

The terminal device 2 connects to the customized webpage generation device 1 through a network 3, such as the Internet, an intranet, or any other suitable communication network. The terminal device 2 includes a browser 20 for displaying a customized webpage in response to input. In one embodiment, the terminal device may be a personal computer, a notebook computer, a mobile phone, a personal digital assistant (PDA), or any suitable communication device.

The webpage generation unit 10 may include a plurality of functional modules including one or more computerized instructions that are stored in the storage system 11 and executed by the at least one processor 12. In one embodiment, the storage system 11 may be an internal storage device, such as a random access memory (RAM) for temporary storage of information, and/or a read only memory (ROM) for permanent storage of information. In some embodiments, the storage system 11 may also be an external storage device, such as an external hard disk, a storage card, or a data storage medium.

In one embodiment, the webpage generation unit 10 includes a file folder creation module 101, a language analysis module 102, a data translation module 103, and a webpage generation module 104. The modules 101-104 may comprise computerized code in the form of one or more programs that are stored in the storage system 11. The computerized code includes instructions that are executed by the at least one processor 12 to provide functions for modules 101-104. In general, the word “module,” as used herein, refers to logic embodied in hardware or firmware, or to a collection of application instructions, written in a programming language. The application instructions in the modules may be embedded in firmware, such as an erasable programmable read only memory (EPROM). The modules described herein may be implemented as either application and/or hardware modules and may be stored in any type of computer-readable medium or other storage device.

The file folder creation module 101 is operable to create a root folder in the storage system 11. In the embodiment, the root folder includes a base folder and a plurality of language folders. Each of the language folders includes a webpage file with a corresponding language, such as English, Chinese, and Japanese, for example. The root folder includes a plurality of common webpage files for generating a common webpage. The common webpage files may include a hypertext markup language (HTML) file, a cascading style sheet (CSS) file, a JavaScript file, and an image file. The HTML file records content of the common webpage. The CSS file is used to display different styles of the common webpage on the browser 20. The image file records image data of the common webpage. The JavaScript file is used to translate the content of the common webpage into data with a required language of the customized webpage. The required language may be English, Chinese, and Japanese, for example.

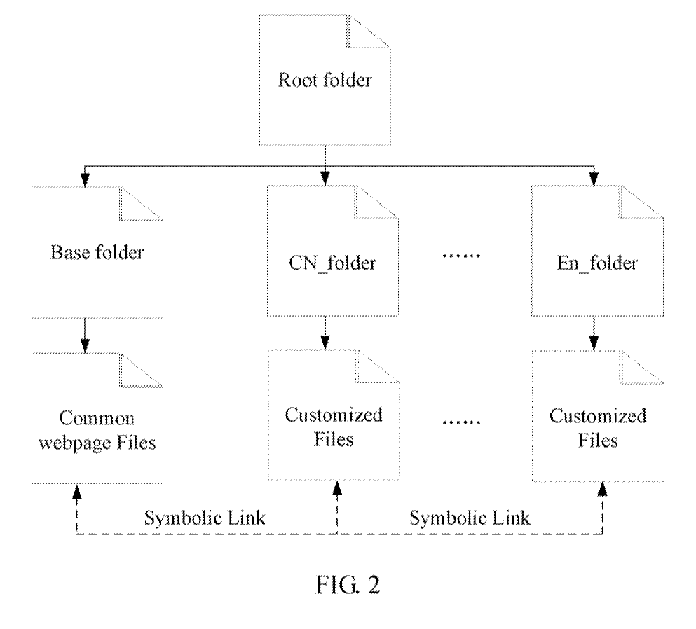

The file folder creation module 101 is further operable to create a symbolic link between each of the language folders and the base folder. In one example with respect to FIG. 2, each of the language folders corresponds to one language. The Cn_folder corresponds to a Chinese folder, the Jp_folder corresponds to a Japanese folder, and the En_folder corresponds to an English folder. Each of the language folders includes a customized file with the corresponding language. Each of the customized files records different display styles of a customized webpage displayed on the browser 20 with the corresponding language. In the embodiment, each of the language folders can share with the common webpage files of the base folder through the symbolic link. Such share mechanism can avoid to repeatedly storing same contents of the customized webpage in each of the language folders, so as to save the storage spaces of the storage system 11.

The language analysis module 102 is operable to receive a web address sent from the browser 20 of the terminal device 2, analyze the web address to determine which language is required by a user, and locate a language folder from the root folder according to the required language. For example, when the user inputs the web address, such as http://www.google.com.cn, the language analysis module 102 determines that the required language is Chinese according to the web address, and locates the Chinese folder (i.e., Cn_folder) from the root folder according to the required language.

The data translation module 103 is operable to obtain common webpage files from the root folder through the symbolic link, and translate content of the common webpage files into data in the required language, and store the translated data into a JavaScript file. The data translation module 103 is further operable to determines whether the language folder has a customized file. Upon the condition that the language folder has a customized file, the data translation module 103 reads the customized file from the language folder and adds the customized file to the JavaScript file.

The webpage generation module 104 is operable to generate an HTML file corresponding to the required language according to the JavaScript file, send the HTML file to the terminal device 2 for generating a customized webpage, and display the customized webpage on the browser 20 according to the HTML file.

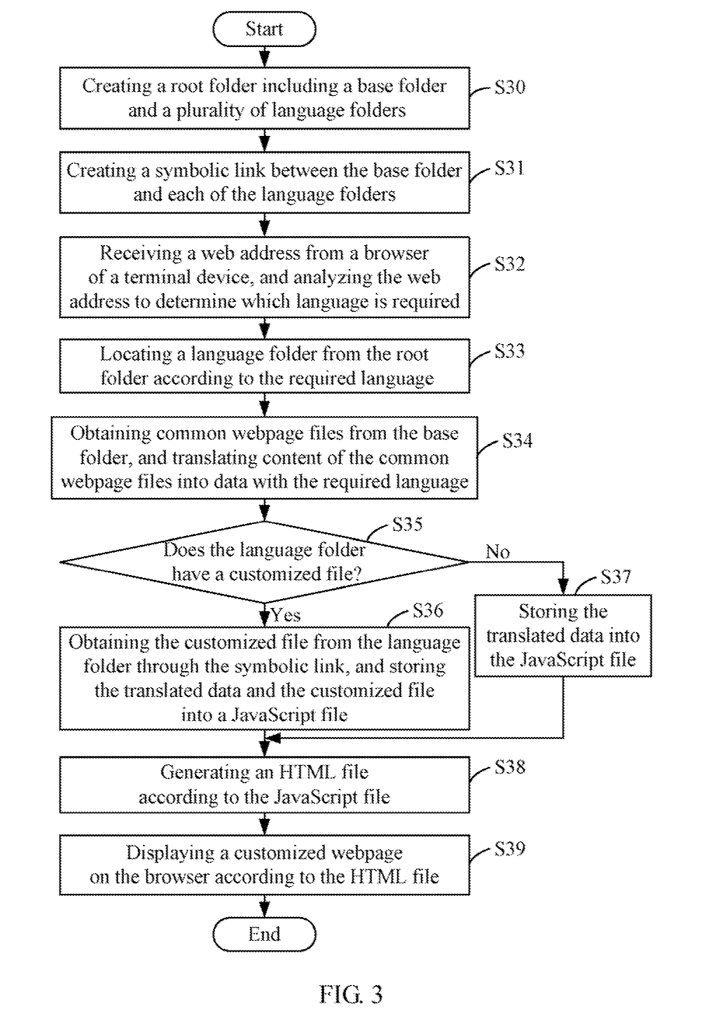

FIG. 3 is a flowchart of one embodiment of a method for generating a customized webpage by using the computing device 1 of FIG. 1. In the embodiment, the method can generate a customized webpage that adapts to user requirements, and displays the customized webpage on the terminal device 2. Depending on the embodiment, additional blocks may be added, others removed, and the ordering of the blocks may be changed.

In block S30, the file folder creation module 101 creates a root folder in the storage system 11. As mentioned above, the root folder includes a base folder and a plurality of language folders. The root folder includes a plurality of common webpage files for generating a common webpage. The common webpage files may include an HTML file, a CSS file, a JavaScript file, and an image file.

In block S31, the file folder creation module 101 creates a symbolic link between each of the language folders and the base folder. In one example with respect to FIG. 2, each of the language folders corresponds to one language. The Cn_folder corresponds to a Chinese folder, the Jp_folder corresponds to a Japanese folder, and the En_folder corresponds to an English folder. Each of the language folders includes a customized file with the corresponding language. Each of the customized files records different display styles of a customized webpage displayed on the browser 20 with the corresponding language.

In block S32, the language analysis module 102 receives a web address sent from the browser 20 of the terminal device 2, analyzes the web address to determine which language is required by a user. In block S33, the language analysis module 102 obtains the required language from the web address, and locates a language folder from the root folder according to the required language. For example, when the user inputs the web address, such as http://www.google.com.cn, the language analysis module 102 determines that the required language is Chinese according to the web address, and locates the Chinese folder (i.e., Cn_folder) from the root folder according to the required language.

In block S34, the data translation module 103 obtains common webpage files from the root folder through the symbolic link, and translates content of the common webpage files into data in the required language. For example, the data translation module 103 reads a common webpage file from the root folder, and translates the content of the common webpage file into data with Chinese.

In block S35, the data translation module 103 determines whether the language folder has a customized file. If the language folder has a customized file, in block S36, the data translation module 103 obtains the customized file from the language folder, and stores the customized file and the translated data into a JavaScript file. Otherwise, if the language folder have no customized file, in block S37, the data translation module 103 stores the translated data into the JavaScript file.

In block S38, the webpage generation module 104 generates an HTML file corresponding to the required language according to the JavaScript file, and sends the HTML file to the terminal device 2 for displaying a customized webpage on the browser 20. In block S39, the terminal device 2 displays the customized webpage on the browser 20 according to the HTML file.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device for generating a customized webpage, the computing device comprising:
a storage system;
at least one processor; and
one or more programs that are stored in the storage system and are executed by the at least one processor, the one or more programs comprising:
a file folder creation module operable to create a root folder comprising a base folder and a plurality of language folders in the storage system, and create a symbolic link between each of the language folders and the base folder;
a language analysis module operable to analyze a web address sent from a terminal device to determine which language is required to display a customized webpage on a browser of the terminal device, and locate a language folder from the root folder according to the required language;
a data translation module operable to obtain common webpage files from the root folder through the symbolic link, translate content of the common webpage files into data in the required language, obtain a customized file from the language folder, and store the customized file and the translated data into a JavaScript file; and
a webpage generation module operable to generate a hypertext markup language (HTML) file according to the JavaScript file, and display the customized webpage on the browser of the terminal device according to the HTML file.

2. The computing device according to claim 1, wherein the data translation module is further operable to determine whether the language folder has the customized file, and store the translated data into the JavaScript file upon the condition that the language folder has no customized file.

3. The computing device according to claim 1, wherein the root folder comprises a plurality of common webpage files for generating a common webpage.

4. The computing device according to claim 3, wherein the common webpage files comprise a cascading style sheet (CSS) file, an image file, the HTML file, and the JavaScript file.

5. The computing device according to claim 1, wherein each of the language folders corresponds to one language, and is shared with the common webpage files of the base folder through the symbolic link.

6. The computing device according to claim 1, wherein the customized file records a display style of the customized webpage displayed on the browser in the required language.

7. A method for generating a customized webpage, the method comprising:
creating a root folder in a storage system, the root folder comprising a base folder and a plurality of language folders;
creating a symbolic link between each of the language folders and the base folder;
analyzing a web address sent from a terminal device to determine which language is required to display a customized webpage on a browser of the terminal device;
locating a language folder from the root folder according to the required language;
obtaining common webpage files from the root folder through the symbolic link, and translating content of the common webpage files into data in the required language;
determining whether the language folder has a customized file;
obtaining the customized file from the language folder and storing the customized file and the translated data into a JavaScript file, if the language folder has a customized file;
generating a hypertext markup language (HTML) file according to the JavaScript file; and
displaying the customized webpage on the browser of the terminal device according to the HTML file.

8. The method according to claim 7, further comprising:
storing the translated data into the JavaScript file upon the condition that the language folder has no customized file.

9. The method according to claim 7, wherein the root folder comprises a plurality of common webpage files for generating a common webpage.

10. The method according to claim 9, wherein the common webpage files comprise a cascading style sheet (CSS) file, an image file, the HTML file, and the JavaScript file.

11. The method according to claim 7, wherein each of the language folders corresponds to one language, and is shared with the common webpage files of the base folder through the symbolic link.

12. The method according to claim 7, wherein the customized file records a display style of the customized webpage displayed on the browser in the required language.

13. A storage medium having stored thereon instructions that, when executed by at least one processor of a computing device, causes the computing device to perform a method for generating a customized webpage, the method comprising:
creating a root folder in a storage system, the root folder comprising a base folder and a plurality of language folders;
creating a symbolic link between each of the language folders and the base folder;
analyzing a web address sent from a terminal device to determine which language is required to display a customized webpage on a browser of the terminal device;
locating a language folder from the root folder according to the required language;
obtaining common webpage files from the root folder through the symbolic link, and translating content of the common webpage files into data in the required language;
determining whether the language folder has a customized file;
obtaining the customized file from the language folder and storing the customized file and the translated data into a JavaScript file, if the language folder has a customized file;
generating a hypertext markup language (HTML) file according to the JavaScript file; and
displaying the customized webpage on the browser of the terminal device according to the HTML file.

14. The storage medium according to claim 13, wherein the method further comprises:
storing the translated data into the JavaScript file upon the condition that the language folder has no customized file.

15. The storage medium according to claim 13, wherein the root folder comprises a plurality of common webpage files for generating a common webpage.

16. The storage medium according to claim 15, wherein the common webpage files comprise a cascading style sheet (CSS) file, an image file, the HTML file, and the JavaScript file.

17. The storage medium according to claim 13, wherein each of the language folders corresponds to one language, and is shared with the common webpage files of the base folder through the symbolic link.

18. The storage medium according to claim 13, wherein the customized file records a display style of the customized webpage displayed on the browser in the required language.
